(19) United States
(12) Patent Application Publication
(10) Pub. No.: US 2022/0145950 A1
(43) Pub. Date: May 12, 2022

(54) DRUM BRAKE FOR VEHICLE

(71) Applicant: MANDO CORPORATION, Gyeonggi-do (KR)

(72) Inventor: Weonchan KO, Gyeonggi-do (KR)

(21) Appl. No.: 17/430,707

(22) PCT Filed: Oct. 30, 2019
(86) PCT No.: PCT/KR2019/014507

§ 371 Date: Aug. 12, 2021

(30) Foreign Application Priority Data
Feb. 15, 2019 (KR) 10-2019-0017713

(51) Int. Cl. F16D 51/24

(52) U.S. Cl. CPC F16D 51/24; F16D 2121/04

(57) ABSTRACT

Disclosed herein a drum brake for a vehicle includes a drum rotating together with a wheel of the vehicle, a pair of brake shoes generating a braking force by friction with an inner surface of the drum, and a wheel cylinder provided between one ends of the pair of brake shoes to operate the pair of brake shoes outwardly, wherein the wheel cylinder includes a pair of pistons configured to press and release the pair of brake shoes, a cylinder configured to accommodate the pair of pistons movable forward and backward, and a pair of sealing members inserted into annular recessed grooves formed on an inner surface of the cylinder, and each of the sealing members returns the pair of pistons when a pressure of the pistons is released.

### TECHNICAL FIELD

The disclosure relates to a drum brake for a vehicle, and more particularly, to a drum brake for a vehicle having a wheel cylinder.

### BACKGROUND ART

Generally, a drum brake for a vehicle refers to a device that generates a friction by compressing a brake shoe with a lining to an inner surface of a cylindrical drum rotating together with wheels of the vehicle, and the vehicle is stopped by a braking force generated at this time.

A conventional drum brake for a vehicle includes not only a hydraulic braking (referred to as a service brake) function for braking when vehicle is driven, but also a parking braking (referred to as a parking brake) function for maintaining a braked state when the vehicle is parked.

A drum brake for a vehicle is provided with a pair of brake shoes inside a drum rotating together with wheels of the vehicle, and the pair of brake shoes are provided with a lining to generate a braking force through a friction with an inner surface of the drum.

In addition, a drum brake for a vehicle is provided with a wheel cylinder that is provided between one ends of a pair of brake shoes to outwardly operate the pair of brake shoes, and when a hydraulic braking is implemented, applies a hydraulic pressure to a piston provided inside the wheel cylinder to press the pair of brake shoes. In addition, when the hydraulic braking is released, the pair of brake shoes return to their original positions by a return spring connecting the pair of brake shoes or a return spring connecting a pair of pistons.

In the case of a drum brake for a vehicle, if a hand lever installed inside the vehicle is pulled when a parking brake is applied, a parking lever connected to the hand lever with a cable operates, and then the parking lever operates a pair of brake shoes outward to perform the parking brake. In this case, the drum brake includes an adjuster that maintains a constant gap between the brake shoes and the drum so that the parking lever may effectively perform the parking brake.

However, when a drum brake for a vehicle does not have a parking brake function and is provided as a service brake having only a hydraulic brake function, the above-described components are not required. In other words, when a drum brake for a vehicle is used exclusively for the service brake, the configuration may be simplified to reduce a weight of the vehicle, manufacturing cost, and a packaging.

### DISCLOSURE

### Technical Problem

The disclosure is directed to providing a drum brake for a vehicle capable of reducing a weight of the vehicle, a packaging, and a manufacturing cost by simplifying the configuration.

Further, the disclosure is directed to providing a drum brake for a vehicle that is easy to assemble and may improve productivity.

Further, the disclosure is directed to providing a drum brake for a vehicle that implements only hydraulic braking.

### Technical Solution

In accordance with one aspect of the disclosure, a drum brake for a vehicle includes a drum rotating together with a wheel of the vehicle, a pair of brake shoes generating a braking force by friction with an inner surface of the drum, and a wheel cylinder provided between one ends of the pair of brake shoes to operate the pair of brake shoes outwardly, wherein the wheel cylinder includes a pair of pistons configured to press and release the pair of brake shoes, a cylinder configured to accommodate the pair of pistons movable forward and backward, and a pair of sealing members inserted into annular recessed grooves formed on an inner surface of the cylinder, and each of the sealing members allows the pair of pistons to return original positions when a pressure of the pistons is released.

Each of the sealing members may be made of an elastic material.

The wheel cylinder may further include a pair of dust covers provided at opposite ends of the cylinder to prevent an inflow of foreign substances, and each of the dust covers may have one side coupled to the cylinder and the other side coupled to the piston to return the piston when the pressure of the pistons is released.

Each of the dust covers may be made of an elastic material.

### Advantageous Effects

The drum brake for a vehicle according to an embodiment of the disclosure can simplify the configuration, thereby reducing the weight of the vehicle, the packaging, and the manufacturing cost.

The drum brake for a vehicle according to an embodiment of the disclosure can easily assemble and improve productivity.

The drum brake for a vehicle according to an embodiment of the disclosure can implement only hydraulic braking.

### DESCRIPTION OF DRAWINGS

FIG. 1 is a cross-sectional view showing a drum brake for a vehicle according to an embodiment of the disclosure.

FIG. 2 is a cross-sectional view showing a brake release state of a wheel cylinder of the drum brake for a vehicle according to an embodiment of the disclosure.

FIG. 3 is a cross-sectional view showing a braked state of a wheel cylinder of the drum brake for a vehicle according to an embodiment of the disclosure.

### INDUSTRIAL APPLICABILITY

Various embodiments will now be described more fully with reference to the accompanying drawings in which some embodiments are shown. These inventive concepts may, however, be embodied in different forms and should not be construed as limited to the embodiments set forth herein. Rather, these embodiments are provided so that this disclosure is thorough and complete and fully conveys the inventive concept to those skilled in the art. In the drawings, the sizes and relative sizes of layers and regions may be exaggerated for clarity.

In general, a drum brake 1 for a vehicle forces brake shoes 20 and 30 with a lining against an inner surface of a cylindrical drum D rotating together with a wheel of the vehicle to generate frictional force, and refers to a device that stops the vehicle through the generated braking force.

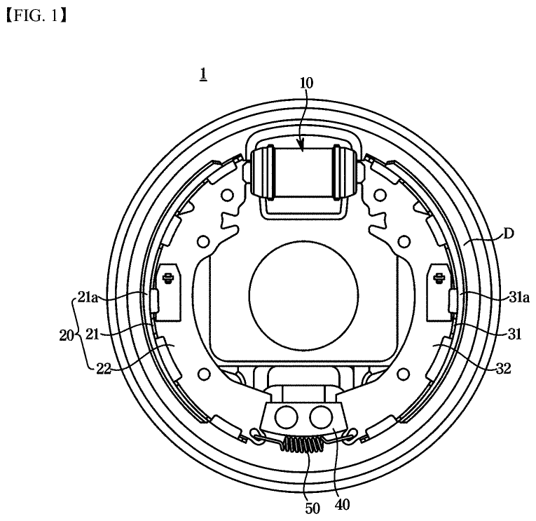

FIG. 1 is a cross-sectional view showing a drum brake 1 for a vehicle according to an embodiment of the disclosure.

Referring to FIG. 1, the drum brake 1 for a vehicle according to an embodiment includes the drum D rotating together with at least one of wheels of the vehicle, a pair of brake shoes 20 and 30 generating a braking force by friction with an inner surface of the drum D, a wheel cylinder 10 provided between one ends of the pair of brake shoes 20 and 30 to outwardly operate the pair of brake shoes 20 and 30, and an anchor block 40 that is provided between the other ends of brake shoes 20 and 30 and rotatably supports the pair of brake shoes 20 and 30.

The pair of brake shoes 20 and 30 are installed in a semicircular shape on opposite sides of the inner surface of the drum D and operate outwardly. More specifically, the pair of brake shoes 20 and 30 are mounted on a back plate (not shown) coupled to a knuckle unit (not shown) of the vehicle and operate outwardly, and may generate the braking force by friction with the inner surface of the drum.

The pair of brake shoes 20 and 30 includes respectively linings 21a and 31a rubbing against the inner surface of the drum D, semicircular rims 21 and 31 having the linings 21a and 31a attached to an outer circumferential surface thereof, and webs 22 and 32 provided on an inner circumferential surface of the rims 21 and 31 for reinforcing and supporting the rigidity.

The wheel cylinder 10 for pressing the webs 22 and 32 of each of the brake shoes 20 and 30 is provided between one ends of the pair of brake shoes 20 and 30 (also referred to as a first and second brake shoes) so that each of the brake shoes 20 and 30 operates outwardly toward the inner surface of the drum D. The wheel cylinder 10 is provided to press the first and second brake shoes 20 and 30 in an outward operation direction by receiving a braking hydraulic pressure formed in a master cylinder. An arrow in FIG. 1 indicates the outward operation direction of the first and second brake shoes 20 and 30.

The other ends of the first and second brake shoes 20 and 30 is rotatably supported through the anchor block 40 provided therebetween. Furthermore, between lower ends of the first and second brake shoes 20 and 30 is connected by a return spring 50 so that the first and second brake shoes 20 and 30 are consistently supported by the anchor block 40.

The anchor block 40 is installed on the back plate (not shown) at a position corresponding to between the other ends of the first and second brake shoes 20 and 30.

The drum brake 1 configured as described above receives the braking hydraulic pressure formed from the master cylinder through the wheel cylinder 10 when a driver presses a brake pedal, and the wheel cylinder 10 that receives the braking hydraulic pressure allows the first and second brake shoes 20 and 30 to operate outwardly from opposite sides around the anchor block 60. Accordingly, the wheels of the vehicle are braked by frictional force formed while the linings 21a and 31a of the pair of brake shoes 20 and 30 rubbing against the inner surface of the drum.

Meanwhile, in a conventional drum brake, when the driver takes her/his foot off the brake pedal and the brake hydraulic pressure applied to the wheel cylinder is released, the drum brake releases a brake of the wheels while the first and second brake shoes 20 and 30, which are operated outwardly toward the inner surface of the drum D, return to their original state through a restoring force of the return spring (not shown) connecting a pair of pistons 140 and 150.

In contrast, the drum brake 1 according to an embodiment uses a roll-back function of sealing members 160 and 170 or dust covers 120 and 130 inside the wheel cylinder 10 to allow the pair of pistons 140 and 150 to return their original positions instead of removing the return spring (not shown).

Furthermore, the drum brake 1 according to an embodiment provides a service brake omitting a parking function. Accordingly, a separate parking lever for implementing the parking function may be omitted, and an adjuster and an adjuster spring for adjusting a gap between the brake shoes and the drum may also be omitted.

Therefore, an embodiment of the disclosure, by simplifying the configuration of the drum brake 1, may have effects such as a weight reduction of the vehicle, an assembling improvement, a manufacturing cost reduction, and a packaging reduction, and the like.

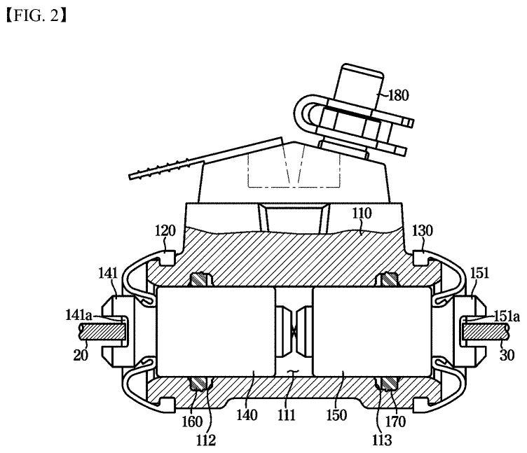

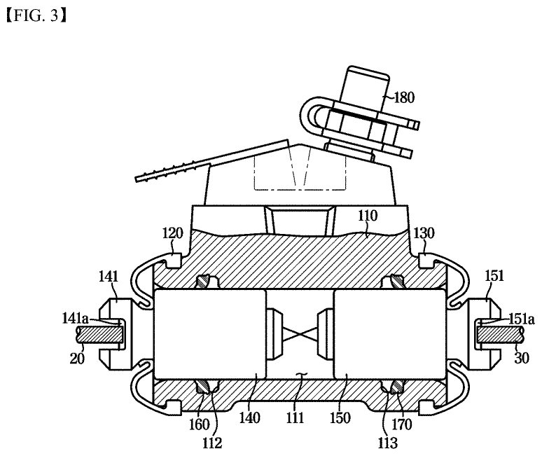

FIG. 2 is a cross-sectional view showing a brake release state of the wheel cylinder 10 of the drum brake 1 for a vehicle according to an embodiment of the disclosure, and FIG. 3 is a cross-sectional view showing a braked state of the wheel cylinder 10 of the drum brake 1 for the vehicle according to an embodiment of the disclosure.

Referring to FIGS. 2 and 3, the wheel cylinder 10 includes the pair of pistons 140 and 150 that press and release the pair of brake shoes 20 and 30, a cylinder 110 for accommodating the pair of pistons 140 and 150 movable forward and backward, and the pair of sealing members 160 and 170 inserted into recessed grooves 112 and 113 formed on an inner surface of the cylinder 110.

The cylinder 110 forms a chamber 111 open on opposite sides to accommodate the pair of pistons 140 and 150 movable forward and backward, and has a coupling portion 114 integrally extended to a rear thereof for coupling with the back plate. The coupling portion 114 is formed a hydraulic flow path (not shown) for guiding hydraulic pressure transmitted from the master cylinder side to the chamber 111 thereinside, and is installed an airport 180 capable of removing air entering the chamber 111 at the rear thereof.

The cylinder 110 forms annular recessed grooves 112 and 113 on the inner surface thereof, and the sealing members 160 and 170 are inserted into the recessed grooves 112 and 113 to maintain airtightness and prevent hydraulic leakage between the pistons 140 and 150 and the inner surface of the cylinder 110. Simultaneously, the sealing members 160 and 170 serve to return the pistons 140 and 150 to their original positions when the pressure of the pistons 140 and 150 is released. Furthermore, the sealing members 160 and 170 may be made of an elastic material to improve elastic restoring force.

The shape of the sealing members 160 and 170 is not limited thereto, and various modifications are possible as long as a function of preventing the hydraulic leakage and a rollback function being present, and should be understood in the same way.

The pair of pistons 140 and 150 are provided so that an outer wall thereof is slidably supported on an inner wall of the chamber 111, and each of the pistons 140 and 150 is integrally provided with contact portions 141 and 151 provided at the ends so as to be in contact with the webs 22 and 32 of the pair of brake shoes 20 and 30, respectively. Insertion grooves 141a and 151a are formed in each of the contact portions 141 and 151 so that the webs 22 and 32 of the pair of brake shoes 20 and 30 are inserted.

The pair of dust covers 120 and 130 are respectively installed at opposite ends of the cylinder 110 to prevent an inflow of foreign substances. At the same time, one side of each of the dust covers 120 and 130 is fastened to a groove recessed on an outer circumferential surface of opposite ends of the cylinder 110, and the other side thereof is fastened to a groove recessed on an outer surface of the contact portions 141 and 151 of the pistons 140 and 150, so that the piston may returned to their original positions when the pressure of the pistons 140 and 150 is released. Furthermore, the dust covers 120 and 130 may be made of an elastic material to improve elastic restoring force.

The shapes of the dust covers 120 and 130 are not limited thereto, and various modifications are possible as long as a function of preventing the inflow of foreign substances and a rollback function being present, and should be understood in the same way.

As described above, the drum brake 1 for the vehicle according to an embodiment of the disclosure, may allow the pistons 140 and 150 to return their original positions by using the sealing members 160 and 170 and the dust covers 120 and 130. Accordingly, even if there is no separate return spring, when the hydraulic pressure is released, the pistons 140 and 150 return to their original positions so that the pair of brake shoes 20 and 30 may maintain the gap in the drum D.

As such, since the drum brake 1 for a vehicle according to an embodiment of the disclosure provides the service brake omitting the parking function, the configuration of a separate parking lever, an adjuster, and a return spring, etc. may be simplified, thereby reducing the weight of the vehicle, improving assembly, reducing manufacturing cost, and reducing packaging, and the like. Furthermore, since the gap between the drum D and the pair of brake shoes 20 and 30 may be determined by a non-uniformity of the inner surface of the drum D, a vibration of the pair of brake shoes 20 and 30, and the like, provision of the service brake is no problem.

Although a few embodiments of the disclosure have been shown and described, it would be appreciated by those skilled in the art that changes may be made in these embodiments without departing from the principles and spirit of the invention, the scope of which is defined in the claims and their equivalents.

1. A drum brake for a vehicle, comprising:
a drum rotating together with a wheel of the vehicle,
a pair of brake shoes generating a braking force by friction with an inner surface of the drum, and
a wheel cylinder provided between one ends of the pair of brake shoes to operate the pair of brake shoes outwardly, wherein
the wheel cylinder comprises:
a pair of pistons configured to press and release the pair of brake shoes,
a cylinder configured to accommodate the pair of pistons movable forward and backward, and
a pair of sealing members inserted into annular recessed grooves formed on an inner surface of the cylinder, and
each of the sealing members returns the pair of pistons when a pressure of the pistons is released.

2. The drum brake of claim 1, wherein
each of the sealing members is made of an elastic material.

3. The drum brake of claim 1, wherein
the wheel cylinder further includes a pair of dust covers provided at opposite ends of the cylinder to prevent an inflow of foreign substances, and
each of the dust covers has one side coupled to the cylinder and the other side coupled to the piston to return the piston when the pressure of the pistons is released.

4. The drum brake of claim 3, wherein
each of the dust covers is made of an elastic material.
